(19) United States
(12) Patent Application Publication
(10) Pub. No.: US 2015/0165530 A1
(43) Pub. Date: Jun. 18, 2015

(54) Tool layout for making boreholes in materials such as fiber composite materials

(71) Applicant: Jakob Lach GmbH & Co. KG, Hanau (DE)

(72) Inventor: Eugen MAURER, Ober-Moerlen (DE)

(21) Appl. No.: 14/483,774

(22) Filed: Sep. 11, 2014

(30) Foreign Application Priority Data
Sep. 13, 2013 (DE) 102013110129.1

(51) Int. Cl. B23B 47/34; B23B 51/04

(52) U.S. Cl. CPC B23B 47/34; B23B 51/04; B23B 2251/68; B23B 2226/27

(57) ABSTRACT

The invention pertains to a tool layout (10) for making boreholes (12) in materials (14) such as fiber composite materials, comprising a cutting tool (16) with a drill shaft (20) having a suction channel (18) and with a drill head (26) having at least one tool blade (22, 24), wherein the drill head (26) has a larger diameter D_{BK} than the drill shaft (20) in order to form an intermediate space (28) between drill shaft (20) and the wall of the borehole, and a suction device (30) coupled to the suction channel (18) of the drill shaft (20) to suction away the shavings removed through at least one suction opening (32, 33) of the drill head (26) coordinated with the at least one cutting blade (22, 24) into the suction channel (18). To improve the suctioning of the shavings and/or the cooling of the tool and work piece, an outer wall (64) of the drill head (26) has at least one recess (64, 66) extending for the entire length of the drill head (26) and emerging into the at least one suction opening (32, 33) as a crossover channel by which a connection is produced between the intermediate space (28) bounding the drill shaft and the suction opening (32, 33).

The invention pertains to a tool layout for making boreholes in materials such as fiber composite materials, comprising a cutting tool with a drill shaft having a suction channel and with a drill head having at least one tool blade, wherein the drill head has a larger diameter than the drill shaft in order to form an intermediate space between drill shaft and the wall of the borehole, and a suction device coupled to the suction channel of the drill shaft to suction away the shavings removed through at least one suction opening of the drill head coordinated with the at least one cutting blade into the suction channel.

Such a device is described in DE 31 43 847 A1. The known device for machining by cutting, especially drilling, milling or grinding of fiber composite materials, is characterized by a supply of air to the machining site of the tool from outside the tool blades and an exhaust drain for carrying away the air supply with resulting shavings as exhaust air inside the tool blades. Such a device is supposed to increase the tool life and prevent the shavings, dust, and the like from the machining site getting into the surroundings, as well as cool down the tool and the work piece and carry away the shavings.

In the known device, the air supply is sucked in via an intermediate space formed between drill shaft and the wall of the borehole, the intermediate space extending around the entire drill head at the periphery. Consequently, supply air is also sucked into areas where no shavings are produced, or where no cooling is needed, so that an effective suctioning of shavings and cooling of the tool and the work piece is impaired.

Starting from this basis, the problem of the invention is to modify a tool layout of the aforementioned kind so that the suctioning of shavings and/or the cooling of the tool and work piece is improved.

The problem is solved according to the invention in that an outer wall of the drill head has at least one recess extending for the entire length of the drill head and emerging into the at least one suction opening as a crossover channel by which a connection is produced between the intermediate space bounding the drill shaft and the suction opening.

The configuration of the invention is distinguished from the prior art in that the air flow through the crossover channel emerging into the suction opening is directed specifically into the area where shavings accumulate and a cooling of the tool and work piece is needed.

According to one preferred embodiment, the at least one recess extends along the outer wall in the direction of rotation of the tool at an angle α in the range of 30°≦α≦60°, preferably α=45°, relative to a radial line defined by a tool blade.

Furthermore, the at least one recess has a depth T which corresponds to a tapering V between the diameter D_{BK} of the drill head and the diameter D_{BS} of the drill shaft.

Thanks to the dimensioning of the margin length and depth of the recess, a flow cross section can be adjusted which corresponds to a flow cross section of the suction opening, so that an unhindered air flow is achieved.

It is provided that a first longitudinal margin of the recess lies in a plane spanned by the tool blade.

For further optimization of the air flow, a center point of the at least one suction opening in the end face is set off in the direction of rotation of the tool at an angle β in the range of 15°≦β≦45°, preferably β=30°, relative to the radial line defined by the tool blade.

According to a preferred embodiment, the drill head has several tool blades with coordinated suction openings, each suction opening being coordinated with a recess as a crossover channel.

A further embodiment is distinguished in that the side wall of the drill shaft has an aperture extending in the direction of the suction opening in order to enlarge the flow cross section.

It is also provided to connect the drill head detachably to the drill shaft.

Further details, advantages and features of the invention will emerge not only from the claims and the features to be found there—in themselves or in combinations—but also from the following description of preferred sample embodiments shown in the drawings.

There are shown:

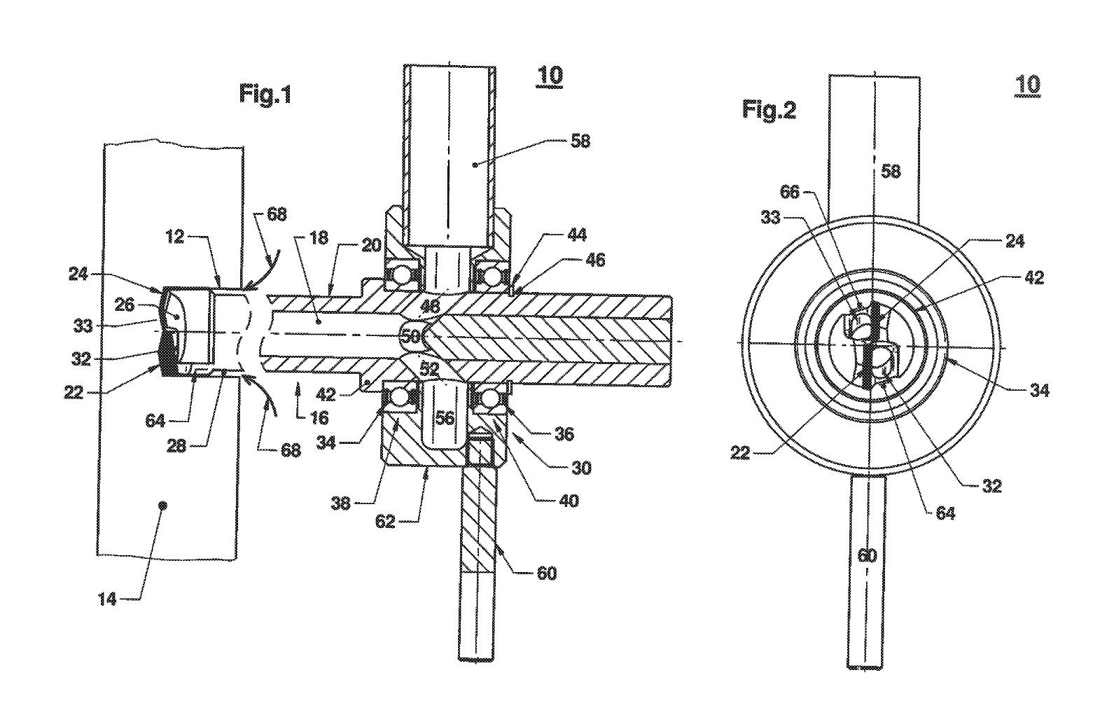

FIG. 1 a first embodiment of a tool layout in the form of a drilling tool with internal shaving suction for making a borehole in a fiber composite material, in partial cross section,

FIG. 2 a bottom view of the tool layout,

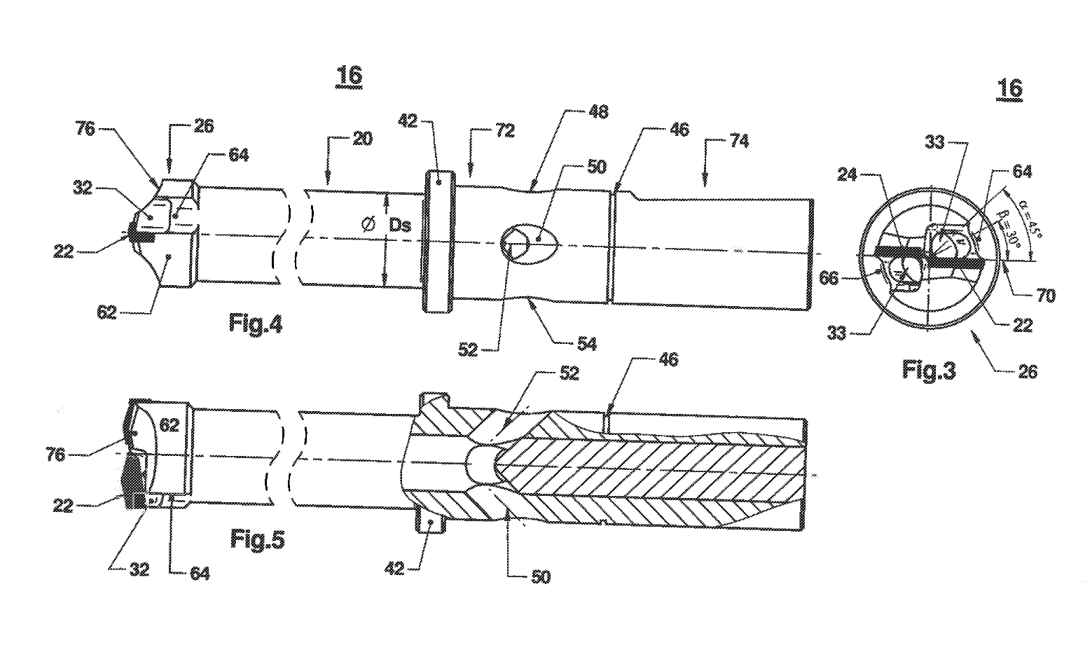

FIG. 3 a bottom view of a first embodiment of a drilling tool,

FIG. 4 a side view of the drilling tool with drill shaft and drill head,

FIG. 5 a side view of the drilling tool of FIG. 4, in partial cross section,

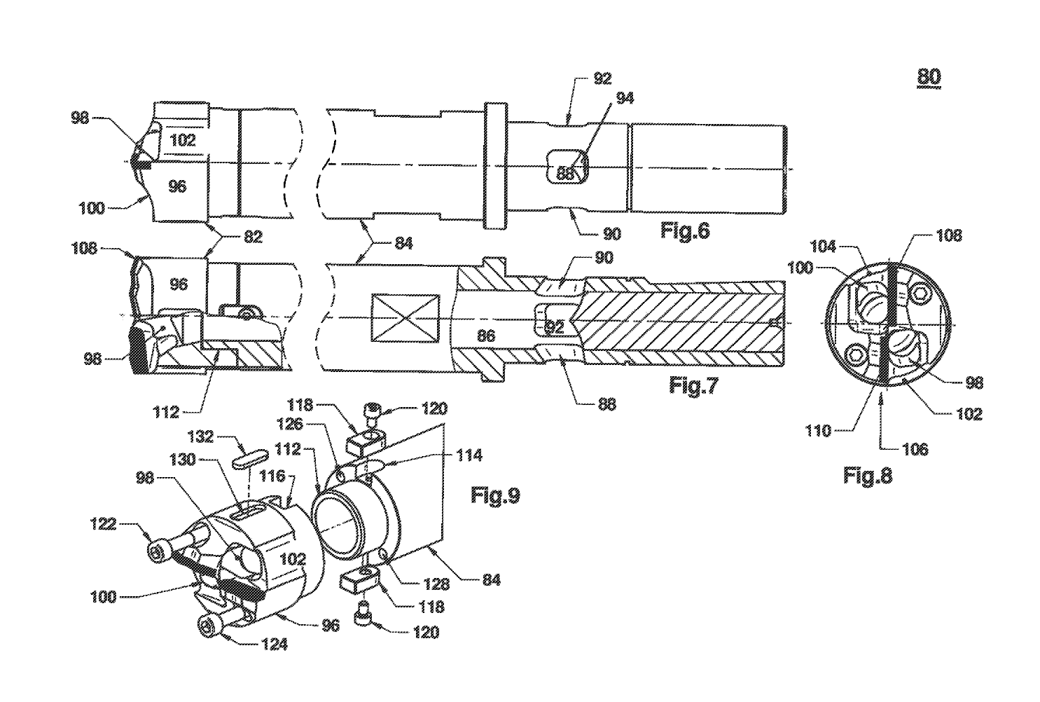

FIG. 6 a second embodiment of a drilling tool with internal shaving suction and interchangeable drill head,

FIG. 7 a side view of the drilling tool per FIG. 6, in partial cross section.

FIG. 8 a bottom view of the drilling tool per FIG. 6,

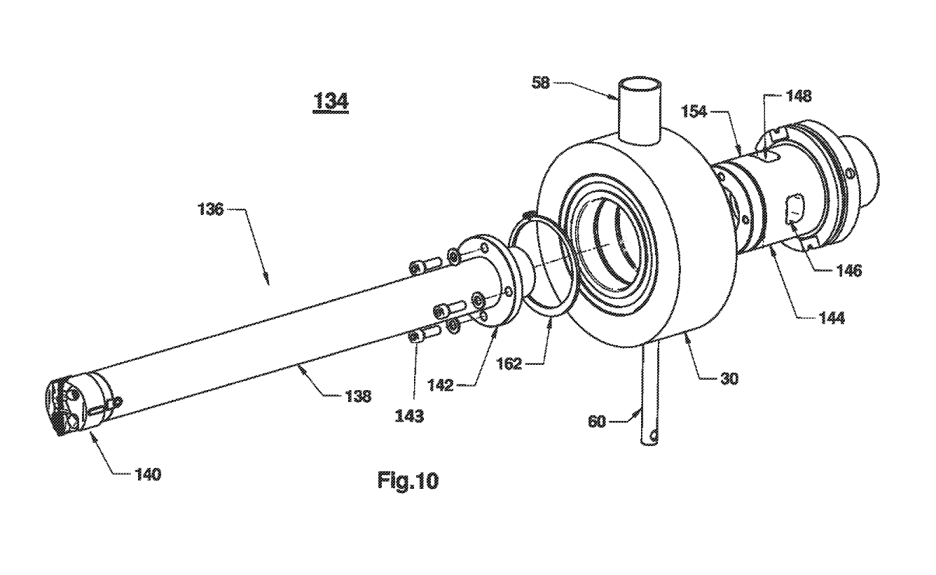

FIG. 9 a three-dimensional exploded view of a drill shaft with removable drill head,

FIG. 10 a second embodiment of a tool layout with internal shaving suction,

FIG. 11 a side view of the tool layout per FIG. 10,

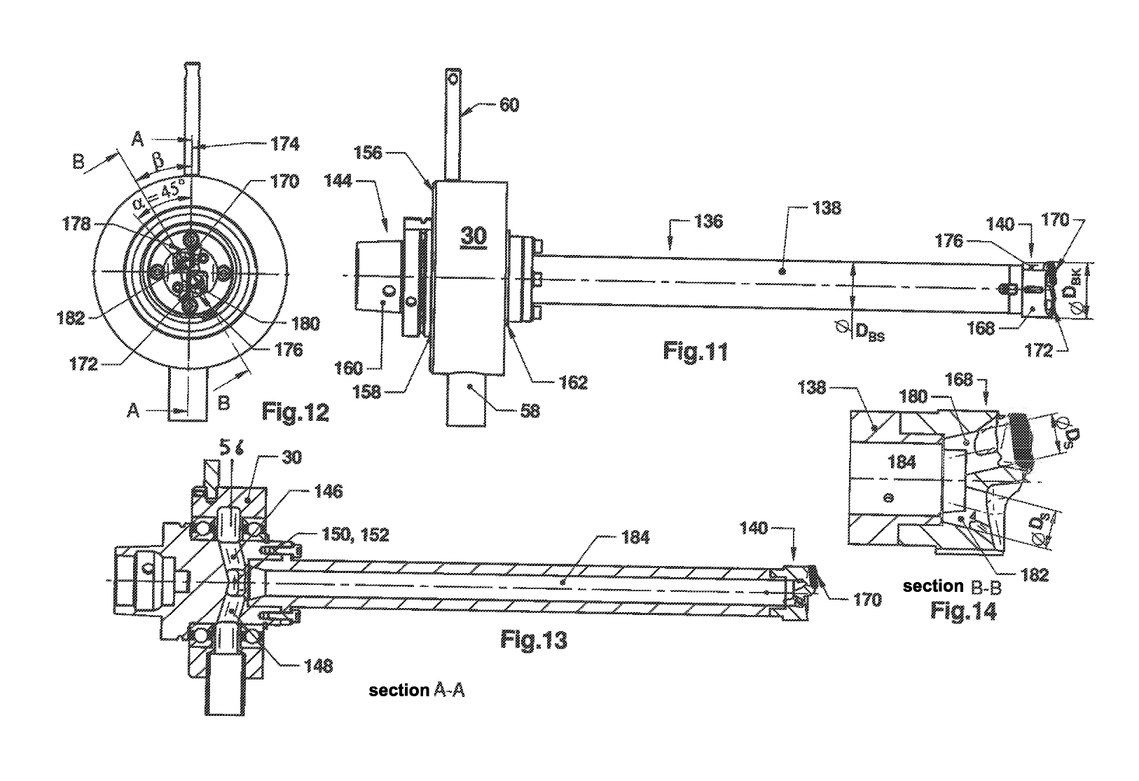

FIG. 12 a bottom view of the tool layout per FIG. 11,

FIG. 13 a cross sectional representation of the tool layout along a cross section A-A per FIG. 12 and

FIG. 14 a cross sectional representation of the drill head along a cross section B-B per FIG. 12.

FIG. 1 shows a tool layout 10, in partial sectional view, for making a borehole 12 in a work piece 14, such as a fiber composite material. The tool layout 10 comprises a material-removing drilling tool 16 with a drill shaft 20 having a suction channel 18 and a drill head 26 having a tool blade 22, 24.

The drill shaft 20 has an outer diameter D_{BS} which is smaller than the outer diameter D_{BK} of the drill head 26, so that when drilling the borehole 12 an intermediate space 28 is formed between a wall of the borehole and an outer surface of the drill shaft 20.

Furthermore, the tool layout 10 comprises a suction device 30 coupled fluidically with the suction channel 18 of the drill shaft 20 for suctioning away the shavings removed (not shown) through at least one suction opening 32 in an end face of the drill head 26. The suction device 30 is configured as a suction ring 30 and mounted by means of ball bearing 34, 36 on a segment of the drill shaft. The ball bearings 34, 36 are received in bearing seats 38, 40 of the suction ring 30, wherein a first ball bearing 34 bears against a circumferential flange 42 of the drill shaft 20 and the suction ring 30 is fixed in position by means of a lock washer 44, which bears against the second ball bearing 36 and engages with a groove 46 in the drill shaft 20.

The suction channel 18 emerges into suction openings 48, 50, 52, 54, which in turn emerge into a fluidically connected annular gap 56 of the suction ring 30, the annular gap 56 being fluidically connected to a suction tube 58 for suctioning away the shavings. In order to secure the suction ring against twisting, a locking rod 60 extends from the suction ring 30 and is secured in a side wall 62 of the suction ring 30, such as by screwing.

According to the invention, the drill head 26 has recesses 64, 66 as crossover channels extending in its outer wall in the longitudinal direction of the drill head 26 and emerging into the suction openings 32, 33 of the end face, as shown in FIG. 2.

Thanks to the crossover channels 64, 66, supply air 68 drawn in through the intermediate space 28 is directed specifically past the tool blade 22, 24 and effectively carries away the heat and shavings produced there.

FIG. 3 shows a bottom view of the drill head 26. The recesses 64, 66 to form the crossover channels extend at an angle along the circumference, the angle α being in the range of α=45°. The center point of the suction opening 32 is set off at an angle β of roughly 30°, relative to a radial line 70 defined by the tool blade 22.

In the embodiment described here, the tool blades 22, 24 extend along the radial line 70 and are situated behind the suction openings and crossover channels 64, 66 in the direction of rotation.

FIGS. 4 and 5 show side views of the drilling tool 16 with drill shaft 20, drill head 26, suction ring seat 72 and clamping chuck 74. The suction openings 32, 33 extend partly in the side wall of the drill head 26 and emerge into the crossover channel 64, 66. An undercut 76 is formed in the circumferential outer wall 62 of the drill head, forming a shaving space coupled with the suction opening.

FIGS. 6 to 9 show an alternative embodiment of a drilling tool 80 with removable drill head 82. The drilling tool 80 comprises a drill shaft 84 with a suction channel 86 or emerges into flow openings 88, 90, 92, 94 in the wall in order to suction exhaust air in the annular gap 56 of the suction ring 30.

The drill head 82 has an outer wall 96, having recesses 102, 104 forming crossover channels in the region of suction openings 98, 100 in the end face, which emerge into the suction openings 98, 100. Along a diagonal 106 are arranged tool blades 108, 110, while the suction openings 98, 100 are arranged in front of the tool blades 104, 106 in the direction of rotation.

In order to connect the tool head 82 to the drill shaft 84, the latter has a cylindrical hollow body 112 at its end face, having a smaller diameter than the drill shaft and being capable of fitting onto the drill head 82. Moreover, in the area of the interface between drill shaft 84 and drill head 82 there are recesses 114, 116 extending in the longitudinal direction and corresponding to each other, in which a drive wedge 118 can be inserted for fixation of the drill head 82 and prevented from twisting by means of a fastening element 120, such as a screw.

Furthermore, there is a fixation by fastening elements 122, 124 such as screws, which extend in the axial direction through the outer margin segment 96 of the drill head and engage with threaded boreholes 126, 128 in the wall of the drill shaft 84.

Moreover, recesses 130 are made in the outer wall segment 96 in the longitudinal direction, which can receive supporting strips 132 in order to buttress the outer wall 96 relative to the inner wall of the borehole.

FIGS. 10 to 14 show in various views one embodiment of a tool layout 134 with internal shaving suction for making boreholes in fiber composite materials. The tool layout 134 comprises a drilling tool 136 with a drill shaft 138 and a drill head 140, corresponding in its design to the interchangeable drill head 82. The drill shaft 138 is joined by a flange 142 and fastening means 143 to an intermediate adapter 144. In the intermediate adapter there are suction openings 146, 148, 150, 152 in the side wall 154, which interact fluidically with the suction ring 30, having the same construction as was described in regard to FIG. 1. In the assembled state, as shown in FIG. 11, the suction ring 30 rests by an end face 156 against an end stop 158 of the intermediate adapter 144. The intermediate adapter can be coupled by a shoulder piece 160 to a driving mechanism. Furthermore, the suction ring 30 is fixed by a split washer 162, which engages in a groove 164 of the intermediate adapter 144.

FIG. 11 shows a side view of the tool layout 134. The diameter D_{BK} of the drill head 140 is larger than the diameter D_{BS} of the drill shaft 138. Preferably, the diameter D_{BK} of the drill head can be 59 mm, while the diameter D_{BS} of the drill shaft can be 50 mm.

Corresponding to the invented configuration of the already described drill heads 26 and 82, the drill head 140 also has an outer wall 168, which determines the diameter D_{BK} of the drill head 140. At the end face, the drill head has tool blades 170, 172, which extend diagonally along a radial line 174. In the outer wall 168, recesses 176, 178 are formed as crossover channels in the longitudinal direction, emerging into suction openings 180, 182. The recesses 176, 178 extend along the circumference at an angle α, starting from the diagonal line 174, the angle α being around 45°. The center points of the suction openings 180, 182 are situated at an angle β of around 30° relative to the radial line 174 in the direction of rotation of the drilling tool.

FIG. 13 shows a cross sectional representation of the tool layout 134. The drill shaft 138 has a suction channel 184, which couples the suction openings 180, 182 to the suction openings 146, 148, 150, 152 arranged in the intermediate adapter, and emerging into the suction ring 56.

FIG. 14 shows a cross sectional representation of the drill head 140, in which the suction openings 180, 182 are shown that emerge into the suction channel 184. The suction openings 180, 182 have a diameter D_{S} in the range of around 15 mm for a drill head diameter B_{BK} of around 59 mm.

1. Tool layout (10) for making boreholes (12) in materials (14) such as fiber composite materials, comprising a cutting tool (16; 80) with a drill shaft (20; 84) having a suction channel (18; 86) and with a drill head (26; 82) having at least one tool blade (22, 24; 108, 110), wherein the drill head (26; 82) has a larger diameter D_{BK} than the drill shaft (20, 84) in order to form an intermediate space (28) between drill shaft (20, 84) and the wall of the borehole, and a suction device (30) coupled to the suction channel (18; 86) of the drill shaft (20; 84) to suction away the shavings removed through at least one suction opening (32, 33; 98, 100) of the drill head (26; 82) coordinated with the at least one cutting blade (22, 24; 108, 110) into the suction channel (18; 86),
characterized in that
an outer wall (64; 96) of the drill head (26; 82) has at least one recess (64, 66;
102, 104) extending for the entire length of the drill head (26; 82) and emerging into the at least one suction opening (32, 33; 98, 100) as a crossover channel by which a connection is produced between the intermediate space (28) bounding the drill shaft and the suction opening (32, 33; 98, 130).

2. Tool layout according to claim 1,
characterized in that
the at least one recess (64, 66; 102, 104) extend along the outer wall (62; 96) in the direction of rotation of the tool (20, 80) at an angle a in the range of 30°≦α≦60°, preferably α=45°, relative to a radial line defined by a tool blade (22, 24; 108, 110).

3. Tool layout according to claim 1,
characterized in that
the at least one recess (64, 66; 102, 104) has a depth T which corresponds to a tapering V between the diameter D_{BK} of the drill head (26; 82) and the diameter D_{BS} of the drill shaft (20; 84).

4. Tool layout according to claim 1,
characterized in that
a center point of the at least one suction opening (32, 33; 98, 120) in the end face is set off in the direction of rotation of the tool at an angle β in the range of 15°≦β≦45°, preferably β=30°, relative to a radial line (70) defined by the tool blade (22, 24; 108, 110).

5. Tool layout according to claim 1,
characterized in that
the recess (64, 66; 102, 104) projected onto a diagonal running perpendicular to the at least one tool blade (22, 24; 108, 110) has a clear width W which is greater than or equal to a diameter D_{S} of the suction opening.

6. Tool layout according to claim 1,
characterized in that
the drill head (26; 82) has several tool blades (22, 24; 108, 110) with coordinated suction openings (32, 33; 108, 110), each suction opening (32, 33; 108, 110) being coordinated with a recess (64, 66; 102, 104) as a crossover channel.

7. Tool layout according to claim 1,
characterized in that
the drill head (82; 140) is detachably connected to the drill shaft (20; 84).
